(19) United States
(12) Patent Application Publication
(10) Pub. No.: US 2014/0321471 A1
(43) Pub. Date: Oct. 30, 2014

(54) SWITCHING FABRIC OF NETWORK DEVICE THAT USES MULTIPLE STORE UNITS AND MULTIPLE FETCH UNITS OPERATED AT REDUCED CLOCK SPEEDS AND RELATED METHOD THEREOF

(71) Applicant: MEDIATEK INC., Hsin-Chu (TW)

(72) Inventors: Veng-Chong Lau, New Taipei City (TW); Jui-Tse Lin, Hsinchu County (TW); Li-Lien Lin, Hsinchu City (TW); Chien-Hsiung Chang, Hsinchu County (TW)

(73) Assignee: MEDIATEK INC., Hsin-Chu (TW)

(21) Appl. No.: 14/203,543

(22) Filed: Mar. 10, 2014

Related U.S. Application Data
(60) Provisional application No. 61/816,258, filed on Apr. 26, 2013.

(51) Int. Cl. H04L 12/947

(52) U.S. Cl. CPC H04L 49/25
USPC 370/401

(57) ABSTRACT

A switching fabric of a network device has a load dispatcher, a plurality of store units, a storage device, a plurality of fetch units, and a load assembler. Each of the store units is used to perform a write operation upon the storage device. Each of the fetch units is used to perform a read operation upon the storage device. The load dispatcher is used to dispatch ingress traffic to the store units, wherein a data rate between the load dispatcher and each of the store units is lower than a data rate of the ingress traffic. The load assembler is used to collect outputs of the fetch units to generate egress traffic, wherein a data rate between the load assembler and each of the fetch units is lower than a data rate of the egress traffic.

### CROSS REFERENCE TO RELATED APPLICATIONS

This application claims the benefit of U.S. provisional application No. 61/816,258, filed on Apr. 26, 2013 and incorporated herein by reference.

### BACKGROUND

The disclosed embodiments of the present invention relate to forwarding packets, and more particularly, to a switching fabric of a network device that uses multiple store units and multiple fetch units operated at reduced clock speeds and a related method thereof.

A network switch is a computer networking device that links different electronic devices. For example, the network switch receives an incoming packet generated from a first electronic device connected to it, and transmits a modified packet or an unmodified packet derived from the received packet only to a second electronic device for which the received packet is meant to be received. In general, the network switch has a packet buffer for buffering packet data of packets received from ingress ports, and forwards the packets stored in the packet buffer to egress ports. When the line rate of each of the ingress ports and egress ports is high (e.g., 10 Gbps or 100 Gbps) and the number of ingress/egress ports is large (e.g., 64 or 128), access (read/write) of the packet buffer needs to operate at a very high clock speed, which requires a great amount of time for chip timing convergence and may affect the manufacture yield.

### SUMMARY

In accordance with exemplary embodiments of the present invention, a switching fabric of a network device that uses multiple store units and multiple fetch units operated at reduced clock speeds and a related method thereof are proposed to solve the above-mentioned problem.

According to a first aspect of the present invention, an exemplary switching fabric of a network device is disclosed. The exemplary switching fabric includes a load dispatcher, a plurality of store units, a storage device, a plurality of fetch units, and a load assembler. Each of the store units is used to perform a write operation upon the storage device. Each of the fetch units is used to perform a read operation upon the storage device. The load dispatcher is used to dispatch ingress traffic to the store units, wherein a data rate between the load dispatcher and each of the store units is lower than a data rate of the ingress traffic. The load assembler is used to collect outputs of the fetch units to generate egress traffic, wherein a data rate between the load assembler and each of the fetch units is lower than a data rate of the egress traffic.

According to a second aspect of the present invention, an exemplary method for dealing with ingress traffic of a network device is disclosed. The exemplary method includes: dispatching the ingress traffic to a plurality of store units, wherein an input data rate of each of the store units is lower than a data rate of the ingress traffic; using each of the store units to perform a write operation upon a storage device; using each of a plurality of fetch units to perform a read operation upon the storage device; and combining outputs of the fetch units to generate egress traffic, wherein an output data rate of each of the fetch units is lower than a data rate of the egress traffic.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a diagram illustrating a data-plane switching fabric according to a first embodiment of the present invention.

FIG. 3 is a diagram illustrating a data-plane switching fabric according to a second embodiment of the present invention.

FIG. 4 is a diagram illustrating a data-plane switching fabric according to a third embodiment of the present invention.

FIG. 5 is a diagram illustrating a data-plane switching fabric according to a fourth embodiment of the present invention.

FIG. 6 is a diagram illustrating a control-plane switching fabric according to an embodiment of the present invention.

FIG. 7 is a flowchart illustrating a method for dealing with ingress traffic of a network device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

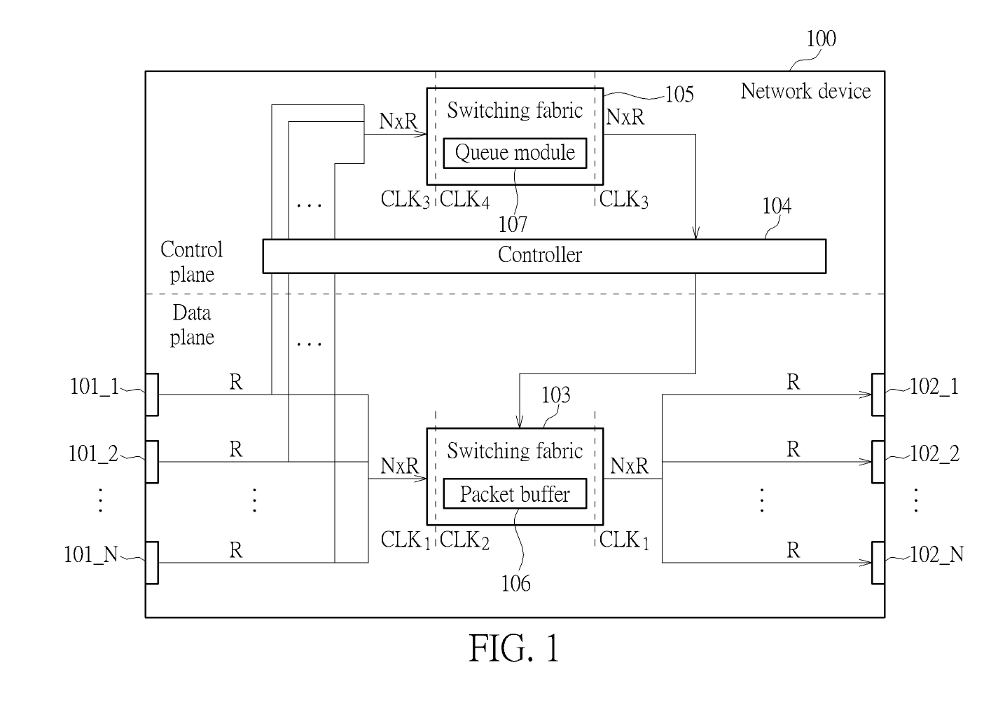

FIG. 1 is a diagram illustrating a network device according to an embodiment of the present invention. By way of example, but not limitation, the network device 100 may be a network switch. The network device 100 includes a plurality of ingress ports 101_1, 101_2, . . . 101_N, a plurality of egress ports 102_1, 102_2, . . . 102_N, a data-plane switching fabric 103, a controller 104, and a control-plane switching fabric 105, where the data-plane switching fabric 103 has a packet buffer 106 implemented therein, and the control-plane switching fabric 105 has a queue module 107 implemented therein. The packet buffer 106 is used to store packet data of packets received by the ingress ports 101_1-101_N. Suppose that the line rate (data rate) of each of the ingress ports 101_1-101_N is R, an equivalent line rate (data rate) of the ingress traffic (i.e., traffic of packet data of incoming packets) for the data-plane switching fabric 103 is N×R. For example, N may be 64 or 128, and R may be 10 Gbps or 100 Gbps. Thus, the multi-input interface of the data-plane switching fabric 103 is operated at a first clock speed CLK₁. Because there are multiple data buses, the clock of each data bus may not run at high clock speed.

In this embodiment, the data-plane switching fabric 103 is configured based on the proposed switching fabric architecture which allows packet buffer write for the ingress traffic under a second clock speed CLK₂, where CLK₁ is not necessarily higher than CLK₂. As can be seen from FIG. 1, the multi-output interface of the data-plane switching fabric 103 is also operated at the first clock speed CLK₁ due to the fact that the line rate (data rate) of each of the egress ports 102_1-102_N is also R. Compared to the conventional data-plane switching fabric design with internal circuit elements (e.g., a single store unit, a single fetch unit and a packet buffer) operated at high clock speeds, the proposed data-plane switching fabric 103 is allowed to have internal circuit elements (e.g., multiple store units, multiple fetch units and/or a packet buffer) operated at reduced clock speeds.

The controller 104 may include a plurality of control circuits required to control the packet switching function of the network device 100. By way of example, but not limitation, the controller 104 may have an en-queuing circuit, a scheduler, and a de-queuing circuit. The en-queuing circuit is arranged to en-queue control information of packets received by the ingress ports 101_1-101_N (e.g., packet identification of each received packet) into the queue module 107. The de-queuing circuit is arranged to de-queue control information of packets from the queue module 107, where an output of the de-queuing circuit would control the actual packet data traffic between the packet buffer 106 and the egress ports 102_1-102_N.

As can be seen from FIG. 1, the multi-input interface of the control-plane switching fabric 105 is operated at a third clock speed CLK₃. Because there are multiple control buses, the clock of each control bus may not run at high clock speed. Specifically, an equivalent line rate (data rate) of the ingress traffic (i.e., traffic of control information of incoming packets) is N×R. As the control-plane switching fabric 105 is configured based on another proposed switching fabric architecture, forwarding en-queuing events is allowed to be operated under a fourth clock speed CLK₄, where CLK₃ is not necessarily higher than CLK₄. It should be noted that CLK₃ may be equal to or different from CLK₁, depending upon actual design consideration. As can be seen from FIG. 1, the multi-output interface of the control-plane switching fabric 105 is also operated at the third clock speed CLK₃. Specifically, an equivalent line rate (data rate) of the egress traffic (i.e., traffic of control information of outgoing packets) is N×R. As the control-plane switching fabric 105 is configured based on the proposed switching fabric architecture, serving de-queuing events is allowed to be operated under a reduced clock speed.

As mentioned above, the data-plane switching fabric 103 is capable of using a reduced clock speed to deal with ingress traffic and egress traffic in the data plane of the network device 100, and the control-plane switching fabric 105 is capable of using a reduced clock speed to deal with ingress traffic and egress traffic in the control plane of the network device 100. Hence, the chip timing convergence can be faster, and the manufacture yield can be improved. Further implementation details of the data-plane switching fabric 103 and the control-plane switching fabric 105 are described as below.

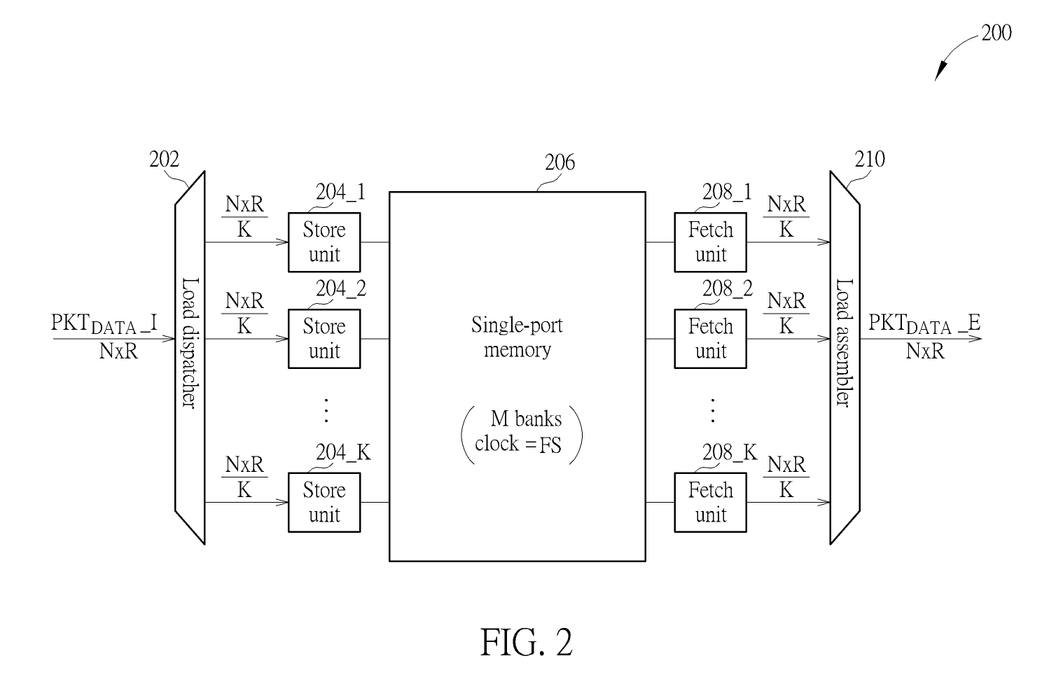

FIG. 2 is a diagram illustrating a data-plane switching fabric according to a first embodiment of the present invention. The data-plane switching fabric 103 shown in FIG. 1 may be realized by the data-plane switching fabric 200 shown in FIG. 2. As shown in FIG. 2, the data-plane switching fabric 200 includes a load dispatcher 202, a plurality of store units 204_1, 204_2, . . . 204_K, a storage device implemented using a single-port memory (e.g., a single-port static random access memory) 206, a plurality of fetch units 208_1, 208_2, . . . 208_K, and a load assembler 210. In this embodiment, the storage device (i.e., single-port memory 206) acts as the packet buffer 106 shown in FIG. 1. Each of the store units 204_1-204_K is arranged to perform a write operation upon the storage device (i.e., single-port memory 206). Each of the fetch units 208_1-208_K is arranged to perform a read operation upon the storage device (i.e., single-port memory 206).

Preferably, the single-port memory 206 is configured to employ packet buffer banking architecture. Specifically, the single-port memory 206 has M banks, where M is an integer larger than one. Therefore, with the help of the packet buffer banking technique, while one bank of the packet buffer is being accessed by one of the fetch units 208_1-208_K, a different bank of the packet buffer can be accessed by one of the store units 204_1-204_K. In other words, the packet buffer banking can be used to access (read/write) different memory banks at the same time in order to scale up the packet switching throughput. Hence, the store units 204_1-204_K and the fetch units 208_1-208_K can choose different banks of the single-port memory 206 for packet data access so that store units 204_1-204_K and fetch units 208_1-208_K can read/write buffer cells simultaneously.

In this embodiment, the packet buffer is implemented using the single-port memory 206. As a single-port memory (1RW) has a single set of addresses and controls, it can only have a single access (read/write) at a time. In other words, the single-port memory 206 has one read port only. Due to the fact that the packet switching throughput is dominated by the read operations performed by the fetch units 208_1-208_K, the single-port memory 206 with one read port active at a time would be operated at its full clock speed FS (i.e., the maximum clock speed supported by the single-port memory 206) for achieving the optimum packet switching throughput.

The load dispatcher 202 is arranged to receive ingress traffic (i.e., traffic of packet data of incoming packets) PKT_{DATA}_{_{—}}I, and dispatch the ingress traffic PKT_{DATA}_{_{—}}I to the store units 204_1-204_K. In this embodiment, the number of store units 204_1-204_K is K. Hence, when the data rate of the ingress traffic PKT_{DATA}_{_{—}}I is N×R, the data rate between each of the store units 204_1-204_K and the load dispatcher 202 is

$$\frac{N \times R}{K} .$$

In other words, the data rate between the load dispatcher 202 and each of the store units 204_1-204_K is lower than the data rate of the ingress traffic PKT_{DATA}_{_{—}}I. Compared to directly processing the ingress traffic PKT_{DATA}_{_{—}}I with a higher data rate N×R, processing a partial ingress traffic with a lower data rate

$$\frac{N \times R}{K}$$

allows the store unit to operate at a reduced clock speed (e.g.,

$$\frac{FS}{K} ) .$$

The load assembler 210 is arranged to collect outputs of the fetch units 208_1-208_K to generate egress traffic (i.e., traffic of packet data of outgoing packets) PKT_{DATA}_{_{—}}E. In this embodiment, the number of fetch units 208_1-208_K is K. Hence, when the data rate of the egress traffic PKT_{DATA}_{_{—}}E is N×R, the data rate between each of the fetch units 208_1-208_K and the load assembler 210 is

$$\frac{N \times R}{K} .$$

In other words, the data rate between the load assembler 210 and each of the fetch units 208_1-208_K is lower than the data rate of the egress traffic PKT_{DATA}_{_{—}}E. Compared to directly generating the egress traffic PKT_{DATA}_{_{—}}E with a higher data rate N×R, generating a partial ingress traffic with a lower data rate

$$\frac{N \times R}{K}$$

allows the fetch unit to operate at a reduced clock speed (e.g.,

$$\frac{FS}{K} ) .$$

With regard to the data-plane switching fabric 200 shown in FIG. 2, the store units 204_1-204_K and the fetch units 208_1-208_K are allowed to operate at reduced clock speeds. In this way, the chip timing convergence can be faster, and the manufacture yield can be improved.

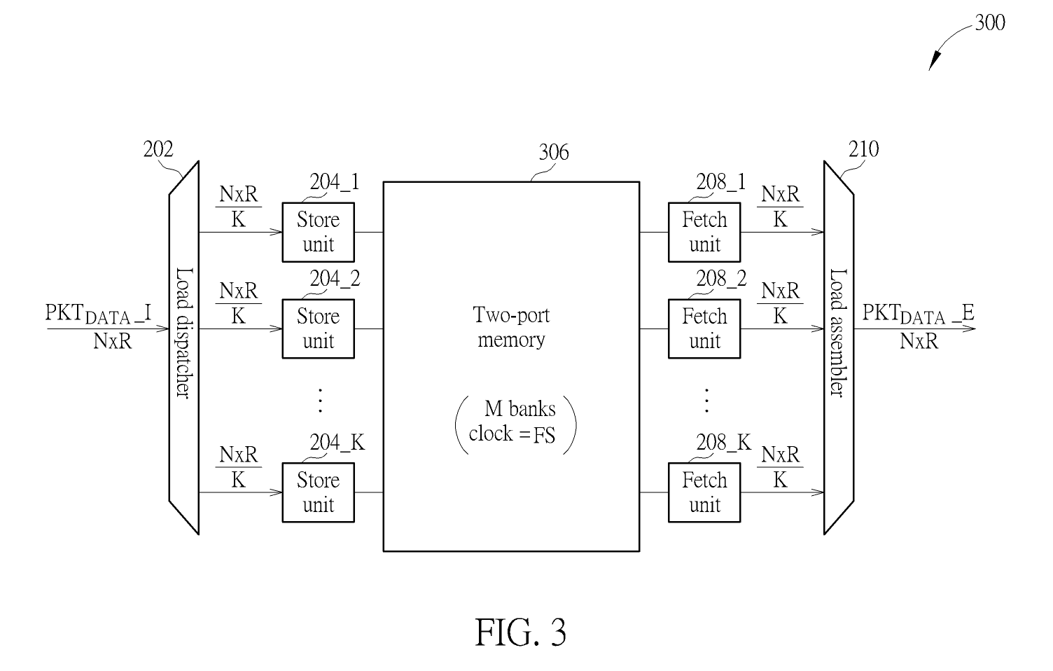

FIG. 3 is a diagram illustrating a data-plane switching fabric according to a second embodiment of the present invention. The data-plane switching fabric 103 shown in FIG. 1 may be realized by the data-plane switching fabric 300 shown in FIG. 3. The configuration of the data-plane switching fabric 300 is similar to that of the data-plane switching fabric 200. The major difference is that a storage device (i.e., a packet buffer) in the data-plane switching fabric 300 is implemented using a two-port memory (e.g., a two-port static random access memory) 306. As a two-port memory (1R1W) has one read port and one write port for addresses and controls, it can have two simultaneous access (one read and one write) at a time. As mentioned above, the packet switching throughput is dominated by the read operations performed by the fetch units 208_1-208_K. Hence, the two-port memory 206 with one read port active at a time would be operated at its full clock speed FS (i.e., the maximum clock speed supported by the two-port memory 306) for achieving the optimum packet switching throughput.

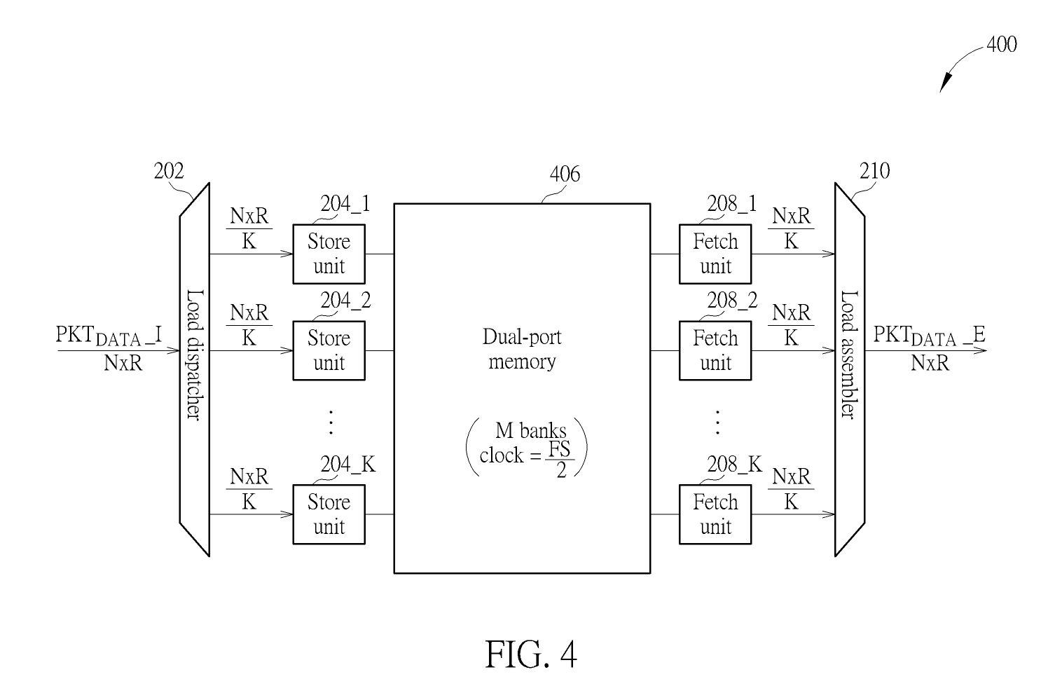

FIG. 4 is a diagram illustrating a data-plane switching fabric according to a third embodiment of the present invention. The data-plane switching fabric 103 shown in FIG. 1 may be realized by the data-plane switching fabric 400 shown in FIG. 4. The configuration of the data-plane switching fabric 400 is similar to that of the data-plane switching fabric 200. The major difference is that a storage device (i.e., a packet buffer) in the data-plane switching fabric 400 is implemented using a dual-port memory (e.g., a dual-port static random access memory) 406. As a dual-port memory (2RW) has two sets of addresses and controls, it can have two simultaneous access (two read, two write, or one read and one write) at a time. As mentioned above, the packet switching throughput is dominated by the read operations performed by the fetch units 208_1-208_K. The dual-port memory 206 with two read ports active at a time may be operated at a reduced clock speed equal to

$$\frac{FS}{2} ,$$

where FS is the full clock speed (i.e., the maximum clock speed supported by the dual-port memory 406). It should be noted that the data-plane switching fabric 400 using a reduced clock speed (i.e.,

$$\frac{FS}{2} )$$

can achieve the same packet switching throughput possessed by the data-plane switching fabric 300 using its full clock speed (i.e., FS).

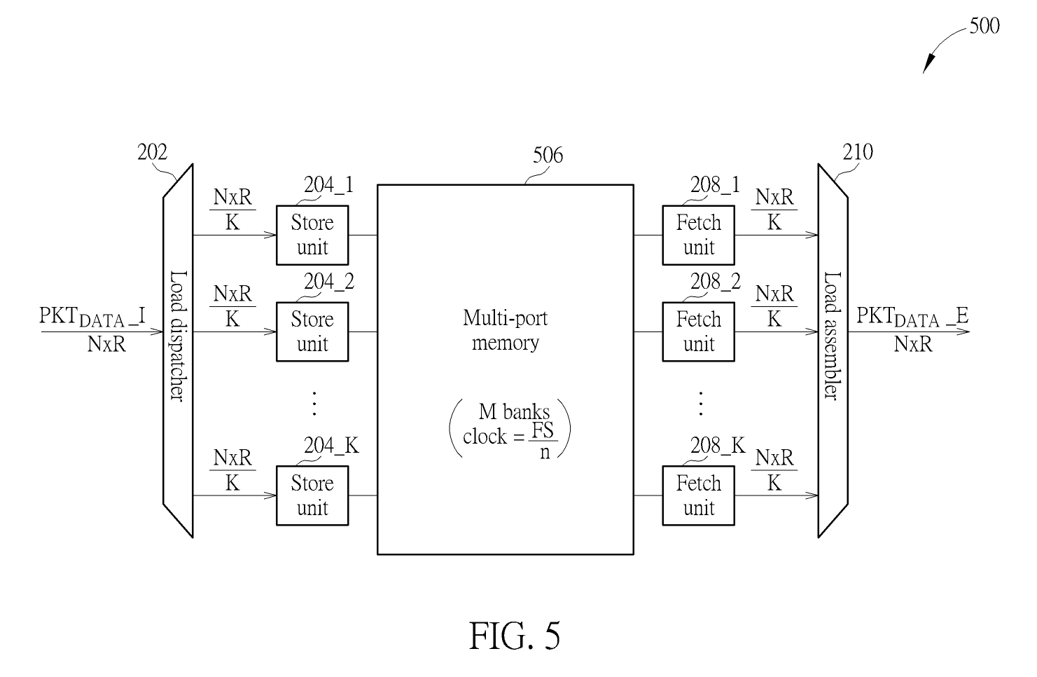

FIG. 5 is a diagram illustrating a data-plane switching fabric according to a fourth embodiment of the present invention. The data-plane switching fabric 103 shown in FIG. 1 may be realized by the data-plane switching fabric 500 shown in FIG. 5. The configuration of the data-plane switching fabric 500 is similar to that of the data-plane switching fabric 200. The major difference is that a storage device (i.e., a packet buffer) in the data-plane switching fabric 500 is implemented using a multi-port memory (e.g., a multi-port static random access memory) 506. With regard to a multi-port memory (nRmW or nRW) having multiple read/write ports (i.e., n read ports and m write ports; or n read/write ports) for addresses and controls, it can have multiple simultaneous access (n read and m write; or n read/write) at a time, where n+m is larger than two for nRmW type (or n is not smaller than two for nRW type). With regard to a multi-port memory (nR/mW) having multiple read/write ports (i.e., n read ports and m write ports) for addresses and controls, it can have multiple simultaneous access (either n read or m write) at a time. In this embodiment, no matter whether the multi-port memory 506 has the nRmW type, the nRW type or the nR/mW type, the number of read ports is equal to or larger than two (i.e., n≧2). It should be noted that the multi-port memory 506 may be a physical multi-port memory or an algorithmic multi-port memory, depending upon actual design consideration. As mentioned above, the packet switching throughput is dominated by the read operations performed by the fetch units 208_1-208_K. The multiple-port memory 506 with n (n≧2) read ports active at a time may be operated at a reduced clock speed equal to

$$\frac{FS}{n} ,$$

where FS is the full clock speed (i.e., the maximum clock speed supported by the multi-port memory 506). It should be noted that the data-plane switching fabric 500 using a reduced clock speed (i.e.,

$$\frac{FS}{n} )$$

can achieve the same packet switching throughput possessed by the data-plane switching fabric 300 using its full clock speed (i.e., FS).

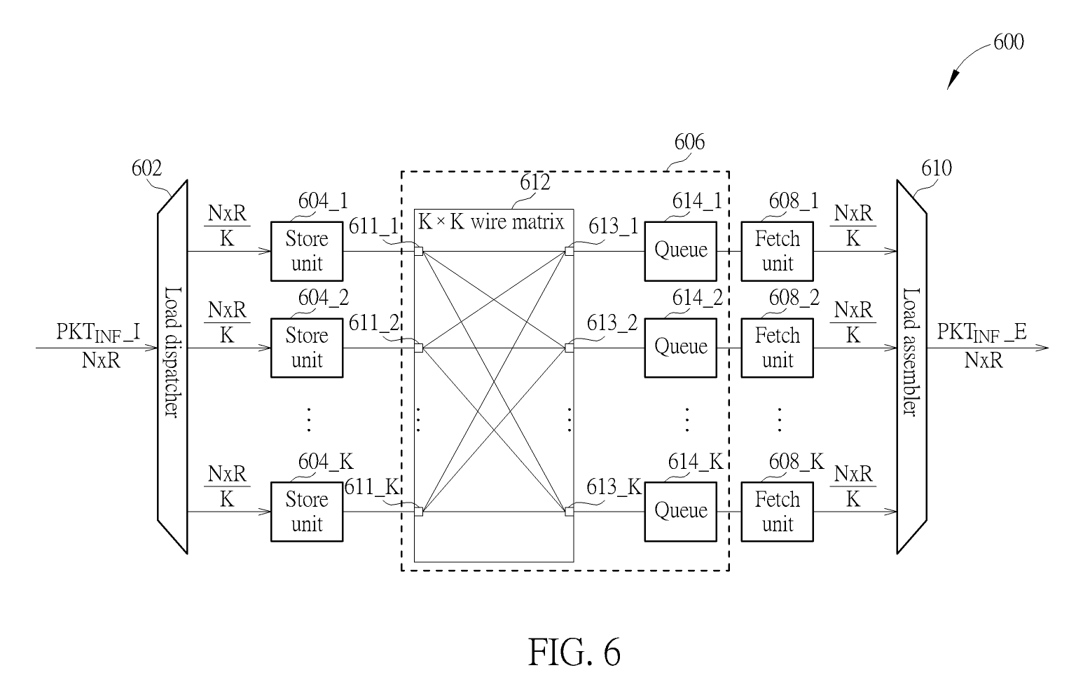

FIG. 6 is a diagram illustrating a control-plane switching fabric according to an embodiment of the present invention. The control-plane switching fabric 105 shown in FIG. 1 may be realized by the control-plane switching fabric 600 shown in FIG. 6. As shown in FIG. 6, the control-plane switching fabric 600 includes a load dispatcher 602, a plurality of store units 604_1, 604_2, . . . 604_K, a storage device 606, a plurality of fetch units 608_1, 608_2, . . . 608_K, and a load assembler 610, where the storage device 606 includes a wire matrix 612 and a plurality of queues 614_1, 614_2, . . . 614_K. In this embodiment, the group of queues 614_1-614_K acts as the queue module 107 shown in FIG. 1. Each of the store units 604_1-604_K is arranged to perform a write operation upon the storage device 606. Each of the fetch units 608_1-608_K is arranged to perform a read operation upon the storage device 606.

The load dispatcher 602 is arranged to receive ingress traffic (i.e., traffic of control information of incoming packets) PKT_{INF}_{_{—}}I, and dispatch the ingress traffic PKT_{INF}_{_{—}}I to the store units 604_1-604_K. In this embodiment, the number of store units 604_1-604_K is K. Hence, when the data rate of the ingress traffic PKT_{INF}_{_{—}}I is N×R, the data rate between each of the store units 604_1-604_K and the load dispatcher 602 is

$$\frac{N \times R}{K} .$$

In other words, the data rate between the load dispatcher 602 and each of the store units 604_1-604_K is lower than the data rate of the ingress traffic PKT_{INF}_{_{—}}I. Compared to directly processing the ingress traffic PKT_{INF}_{_{—}}I with a higher data rate N×R, processing a partial ingress traffic with a lower data rate

$$\frac{N \times R}{K}$$

allows the store unit to operate at a reduced clock speed.

The load assembler 610 is arranged to collect outputs of the fetch units 608_1-608_K to generate egress traffic (i.e., traffic of control information of outgoing packets) PKT_{INF}E. In this embodiment, the number of fetch units 608_1-608_K is K. Hence, when the data rate of the egress traffic PKT_{INF}_{_{—}}E is N×R, the data rate between each of the fetch units 608_1-608_K and the load assembler 610 is

$$\frac{N \times R}{K} .$$

In other words, the data rate between the load assembler 610 and each of the fetch units 608_1-608_K is lower than the data rate of the egress traffic PKT_{INF}_{_{—}}E. Compared to directly generating the egress traffic PKT_{INF}_{_{—}}E with a higher data rate N×R, generating a partial ingress traffic with a lower data rate

$$\frac{N \times R}{K}$$

allows the fetch unit to operate at a reduced clock speed.

With regard to the control-plane switching fabric 600 shown in FIG. 6, the store units 604_1-604_K and the fetch units 608_1-608_K are allowed to operate at reduced clock speeds. In this way, the chip timing convergence can be faster, and the manufacture yield can be improved.

The same packet data of one packet may be forwarded to one destination device or multiple destination devices. Hence, the control information (e.g., the packet identification) of the packet should be properly en-queued into one queue entity or en-queued into multiple queue entities. To achieve this objective, the storage device 606 therefore has the wire matrix 612 disposed between the queues 614_1-614_K and the store units 604_1-604_K. As can be seen from FIG. 6, the wire matrix 612 has a plurality of input nodes 611_1, 611_2, . . . 611_K and a plurality of output nodes 613_1, 613_2, . . . 613_K. The input nodes 611_1-611_K are connected to the store units 604_1-604_K, respectively. The output nodes 613_1-613_K are connected to the queues 614_1-614_K, respectively. Each of the input nodes 611_1-611_K can be connected to one or more output nodes. In other words, one of the store units 604_1-604_K may forward the same en-queuing event to at least a portion (i.e., part or all) of the queues 614_1-614_K. Under a specific packet switching scenario, all of the store units 604_1-604_K may forward respective en-queuing events to the same queue. However, each of the fetch units 608_1-608_K is arranged to only serve a single de-queuing event at a time. In this embodiment, each of the queues 614_1-614_K is implemented using a multi-port memory (e.g., a multi-port static random access memory) having one read port and K write ports.

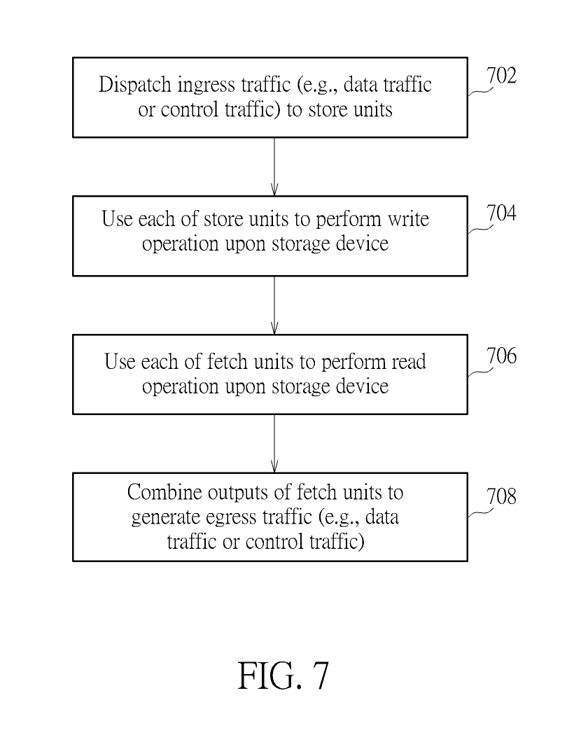

FIG. 7 is a flowchart illustrating a method for dealing with ingress traffic of a network device according to an embodiment of the present invention. Provided that the result is substantially the same, the steps are not required to be executed in the exact order shown in FIG. 7. The method may be employed in one of the data-plane switching fabric and the control-plane switching fabric, and may be briefly summarized as below.

Step 702: Dispatch the ingress traffic (e.g., data traffic or control traffic) to a plurality of store units.

Step 704: Use each of the store units to perform a write operation upon a storage device.

Step 706: Use each of a plurality of fetch units to perform a read operation upon the storage device.

Step 708: Combine outputs of the fetch units to generate egress traffic (e.g., data traffic or control traffic).

As a person skilled in the art can readily understand details of the steps after reading above paragraphs directed to the network device 100, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switching fabric of a network device, comprising:
a storage device;
a plurality of store units, each arranged to perform a write operation upon the storage device;
a plurality of fetch units, each arranged to perform a read operation upon the storage device;
a load dispatcher, arranged to dispatch ingress traffic to the store units, wherein a data rate between the load dispatcher and each of the store units is lower than a data rate of the ingress traffic; and
a load assembler, arranged to collect outputs of the fetch units to generate egress traffic, wherein a data rate between the load assembler and each of the fetch units is lower than a data rate of the egress traffic.

2. The switching fabric of claim 1, wherein the switching fabric is a data-plane switching fabric, and each of the ingress traffic and the egress traffic is traffic of packet data of packets.

3. The switching fabric of claim 2, wherein the storage device is a packet buffer having a plurality of banks; and while a first bank of the packet buffer is being accessed by one of the fetch units, a second bank of the packet buffer is accessed by one of the store units, where the second bank is different from the first bank.

4. The switching fabric of claim 2, wherein the storage device is a packet buffer implemented using a single-port memory with one read port, and the single-port memory is operated at its full clock speed.

5. The switching fabric of claim 2, wherein the storage device is a packet buffer implemented using a two-port memory with one read port, and the two-port memory is operated at its full clock speed.

6. The switching fabric of claim 2, wherein the storage device is a packet buffer implemented using a dual-port memory with two read ports, the dual-port memory is operated at a clock speed equal to FS/2, and FS is a full clock speed of the dual-port memory.

7. The switching fabric of claim 2, wherein the storage device is a packet buffer implemented using a multi-port memory with n read ports, the multi-port memory is operated at a clock speed equal to FS/n, FS is a full clock speed of the multi-port memory, and n is an integer equal to or larger than two.

8. The switching fabric of claim 1, wherein the switching fabric is a control-plane switching fabric, and each of the ingress traffic and the egress traffic is traffic of control information of packets.

9. The switching fabric of claim 8, wherein the storage device comprises:
a wire matrix, having a plurality of input nodes and a plurality of output nodes, wherein the input nodes are coupled to the store units, respectively; and
a plurality of queues, coupled to the output nodes, respectively, wherein each of the queues is coupled between one of the output nodes and one of the fetch units.

10. The switching fabric of claim 9, wherein each of the queues is implemented using a multi-port memory having one read port and K write ports, and K is equal to a number of the store units.

11. A method for dealing with ingress traffic of a network device, comprising:
dispatching the ingress traffic to a plurality of store units, wherein an input data rate of each of the store units is lower than a data rate of the ingress traffic;
using each of the store units to perform a write operation upon a storage device;
using each of a plurality of fetch units to perform a read operation upon the storage device; and
combining outputs of the fetch units to generate egress traffic, wherein an output data rate of each of the fetch units is lower than a data rate of the egress traffic.

12. The method of claim 11, wherein the method is applied to a data plane of the network device, and each of the ingress traffic and the egress traffic is traffic of packet data of packets.

13. The method of claim 12, wherein the storage device is a packet buffer having a plurality of banks; and while a first bank of the packet buffer is being accessed by one of the fetch units, a second bank of the packet buffer is accessed by one of the store units, where the second bank is different from the first bank.

14. The method of claim 12, wherein the storage device is a packet buffer implemented using a single-port memory with one read port, and the method further comprises: configuring the single-port memory to operate at its full clock speed.

15. The method of claim 12, wherein the storage device is a packet buffer implemented using a two-port memory with one read port, and the method further comprises: configuring the two-port memory to operate at its full clock speed.

16. The method of claim 12, wherein the storage device is a packet buffer implemented using a dual-port memory with two read ports, and the method further comprises: configuring the dual-port memory to operate a clock speed equal to FS/2, where FS is a full clock speed of the dual-port memory.

17. The method of claim 12, wherein the storage device is a packet buffer implemented using a multi-port memory with n read ports, and the method further comprises: configuring the multi-port memory to operate at a clock speed equal to FS/n, where FS is a full clock speed of the multi-port memory, and n is an integer equal to or larger than two.

18. The method of claim 11, wherein the method is applied to a control plane of the network device, and each of the ingress traffic and the egress traffic is traffic of control information of packets.

19. The method of claim 18, wherein the storage device comprises a wire matrix and a plurality of queues, and the method further comprises:
coupling a plurality of input nodes of the wire matrix to the store units, respectively; and
coupling a plurality of output nodes of the wire matrix to the queues, respectively, wherein each of the queues is coupled between one of the output nodes and one of the fetch units.

20. The method of claim 19, wherein each of the queues is implemented using a multi-port memory having one read port and K write ports, and K is equal to a number of the store units.
